(19) United States
(12) Patent Application Publication
(10) Pub. No.: US 2022/0005490 A1
(43) Pub. Date: Jan. 6, 2022

(54) ELECTRONIC DEVICE AND CONTROL METHOD THEREFOR

(71) Applicant: SAMSUNG ELECTRONICS CO., LTD., Suwon-si, Gyeonggi-do (KR)

(72) Inventors: Kyoungshin JIN, Suwon-si, Gyeonggi-do (KR); Minsup KIM, Suwon-si, Gyeonggi-do (KR); Jaeyong KIM, Suwon-si, Gyeonggi-do (KR); Byungseok SOH, Suwon-si, Gyeonggi-do (KR); Hyunkyu YUN, Suwon-si, Gyeonggi-do (KR); Jongjin PARK, Seoul (KR); Suhwan JIN, Suwon-si, Gyeonggi-do (KR)

(21) Appl. No.: 17/285,707

(22) PCT Filed: Jun. 7, 2019
(86) PCT No.: PCT/KR2019/006886

§ 371 Date: Apr. 15, 2021

(30) Foreign Application Priority Data
Oct. 17, 2018 (KR) 10-2018-0123830

(51) Int. Cl. G10L 21/0208; H04R 29/00; H04R 3/02

(52) U.S. Cl. CPC G10L 21/0208; G10L 2021/02082; H04R 3/02; H04R 29/001

(57) ABSTRACT

The disclosure relates to an electronic apparatus configured to, identifying that whether a correction of echo elimination on a sound signal which is received through a sound receiver is needed, output a test sound signal to an external speaker, identify a correction value of the echo elimination based on a characteristic difference between the test sound signal and a feedback sound signal received from the external speaker in response to the output test sound signal, and obtain a user voice signal by performing the echo elimination on a sound signal received through the sound receiver based on the correction value.

### TECHNICAL FIELD

The disclosure relates to an electronic apparatus and a control method thereof to perform an echo elimination on an output sound of an external speaker which is received with a user voice, more specifically, to an electronic apparatus and a control method thereof to perform the echo elimination on the output sound of the external speaker according to an installation environment of the external speaker.

### BACKGROUND ART

Recently, as an electronic apparatus that is equipped with a voice recognition function has been widely supplied, it is possible for a user to control various functions of the electronic apparatus using the user's voice command. In case of a television (TV) as an example of the electronic apparatus, while the user is watching an image of a news channel on the TV, the user may speak a voice to instruct a change into a baseball channel, and the TV receives the voice through a microphone, recognizes the voice, and changes into the baseball channel to display an image of the baseball channel according to the recognized voice.

Meanwhile, when the TV receives the user's voice during receiving a sound of the news channel that is output through a speaker, a recognition rate for the user's voice is decreased, but it is possible to prevent the decrease of the voice recognition rate by performing an echo elimination, so called an acoustic echo cancellation (AEC), that is to eliminate the sound of the news channel output through the speaker.

However, because the sound has a different characteristic according to an installation environment of the speaker, for example, if a position of an external speaker is changed while the sound of the news channel is output through the external speaker, there may be a problem that improvement of the voice recognition rate is not achieved since the sound of the news channel after the position change is not eliminated even though an echo elimination on the sound of the news channel before the position change has been performed.

Therefore, a method of improving the voice recognition rate by performing an echo elimination according to the installation environment of the external speaker is required.

### Technical Problem

Accordingly, an aspect of the disclosure is to provide an electronic apparatus and a control method thereof to improve the voice recognition rate by performing the echo elimination according to the installation environment of the external speaker.

### Technical Solution

According to an embodiment of the disclosure, there is provided an electronic apparatus including: a sound receiver; a sound output part configured to connect to an external speaker; and a processor configured to: identify whether a correction of echo elimination on a sound signal which is received through the sound receiver is needed, in response to identifying that the correction is needed, control the sound output part to output a test sound signal, receive through the sound receiver a feedback sound signal corresponding to the output test sound signal, identify a correction value of the echo elimination based on a characteristic difference between the test sound signal and the feedback sound signal, and obtain a user voice signal by performing the echo elimination of the first sound signal on the second sound signal received through the sound receiver based on the identified correction value, while the first sound signal is output to the external speaker through the sound output part.

Here, the processor may be further configured to identify whether the correction is needed based on a change in an installation environment of the external speaker.

Here, the installation environment of the external speaker may include a distance between the electronic apparatus and the external speaker.

Here, the processor may be further configured to: obtain information on a position change of the external speaker sensed by a sensor, and identify a change in the distance between the electronic apparatus and the external speaker based on the obtained information.

Here, the installation environment of the external speaker may include a volume setting of the external speaker.

Here, the processor may be further configured to: obtain information on a magnitude of the sound signal received through the sound receiver, and identify a change in the volume setting of the external speaker based on the obtained information.

Here, the processor may be further configured to identify the change in the installation environment of the external speaker based on a user input.

Here, the processor may be further configured to display a user interface to receive the user input.

Here, the processor may be further configured to identify whether the correction is needed in response to a power-on of the electronic apparatus.

Here, the processor may be further configured to identify the correction value of the echo elimination based on a difference in at least one of a magnitude or a phase between the test sound signal and the feedback sound signal.

Here, the test sound signal may have a frequency of an audible band or an inaudible band.

According to an embodiment of the disclosure, there is provided a method of controlling an electronic apparatus connected to an external speaker, the method including: identifying whether a correction of echo elimination on a sound signal which is received through a sound receiver is needed, in response to identifying that the correction is needed, controlling a sound output part to output a test sound signal, identifying a feedback sound signal received through the sound receiver in response to the output test sound signal, identifying a correction value of the echo elimination based on a characteristic difference between the test sound signal and the feedback sound signal, and obtaining a user voice signal by performing the echo elimination of the first sound signal on the second sound signal received through the sound receiver based on the identified correction value, while the first sound signal is output to the external speaker through the sound output part.

Here, the identifying whether the correction is needed may include identifying whether the correction is needed based on a change in an installation environment of the external speaker.

Here, the installation environment of the external speaker may include a distance between the electronic apparatus and the external speaker.

Here, the identifying whether the correction is needed may include obtaining information on a position change of the external speaker sensed by a sensor, and identifying a change in the distance between the electronic apparatus and the external speaker based on the obtained information.

Here, the installation environment of the external speaker may include a volume setting of the external speaker.

Here, the identifying whether the correction is needed may include obtaining information on a magnitude of the sound signal received through the sound receiver, and identifying a change in the volume setting of the external speaker based on the obtained information.

Here, the identifying whether the correction is needed may include identifying the change in the installation environment of the external speaker based on a user input.

Here, the identifying whether the correction is needed may include displaying a user interface to receive the user input.

According to an embodiment of the disclosure, there is provided a recording medium in which a computer program is stored, the computer program including a computer-readable code to perform a method of controlling an electronic apparatus, connected to an external speaker, the method including: identifying whether a correction of echo elimination on a sound signal which is received through a sound receiver is needed, in response to identifying that the correction is needed, controlling a sound output part to output a test sound signal, identifying a feedback sound signal received through the sound receiver in response to the output test sound signal, identifying a correction value of the echo elimination based on a characteristic difference between the test sound signal and the feedback sound signal, and obtaining a user voice signal by performing the echo elimination of the first sound signal on the second sound signal received through the sound receiver based on the identified correction value, while the first sound signal is output to the external speaker through the sound output part.

### Advantageous Effects

As described above, according to the disclosure, it is possible to provide an electronic apparatus and a control method thereof to improve the voice recognition rate by performing the echo elimination according to the installation environment of the external speaker.

### DESCRIPTION OF DRAWINGS

FIG. 1 illustrates an electronic apparatus of an embodiment of the disclosure that performs an echo elimination.

FIG. 2 illustrates a configuration of the electronic apparatus of FIG. 1.

FIG. 3 illustrates a control method of the electronic apparatus of FIG. 1.

FIG. 4 illustrates an example related to the operation S301 of FIG. 3 where an installation environment of the external speaker is changed.

FIG. 5 illustrates another example related to the operation S301 of FIG. 3 where an installation environment of the external speaker is changed.

FIG. 6 illustrates an example related to the operations S302 through S304 of FIG. 3 to identify the correction value of the echo elimination.

FIG. 7 illustrates another example related to the operations S302 through S304 of FIG. 3 to identify the correction value of the echo elimination.

FIG. 8 illustrates an example related to the operation S305 of FIG. 3 to perform the echo elimination based on the identified correction value.

FIG. 9 illustrates an example related to the operation S301 of FIG. 3 to perform the correction of the echo elimination according to a user input.

FIG. 10 illustrates an example related to the operation S301 of FIG. 3 to perform the correction of the echo elimination in response to power-on of the electronic apparatus.

FIG. 11 illustrates an example related to the operation S302 of FIG. 3 where the test sound signal of an audible or inaudible band is output.

### BEST MODE

Below, embodiments of the disclosure will be described in detail with reference to the accompanying drawings. In the drawings, like numerals or symbols refer to like elements having substantially the same function, and the size of each element may be exaggerated for clarity and convenience of description. However, the technical concept of the disclosure and its key configurations and functions are not limited to those described in the following embodiments. In the following descriptions, details about publicly known technologies or configurations may be omitted if they unnecessarily obscure the gist of the disclosure. In the disclosure, a term “at least one of” a plurality of elements or the like may not refer to all of the plurality of elements but also to each and every possible combination of the elements.

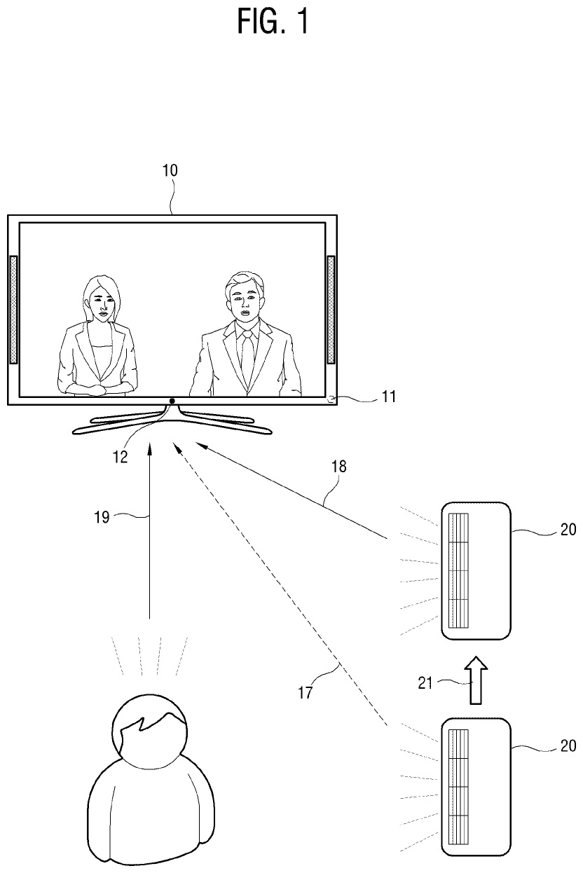

FIG. 1 illustrates an electronic apparatus 10 of an embodiment of the disclosure that performs an echo elimination. As illustrated in FIG. 1, the electronic apparatus 10 of the embodiment has a voice recognition function to perform various functions according to a user voice 19. For example, the electronic apparatus 10 can be embodied as a television (TV) that displays an image, recognize the user voice 19 to instruct performing of various functions that the TV is capable of providing such as power-on/off, channel-up/down, volume-up/down, content search/selection/play/stop, etc., and perform a function corresponding to the recognized user voice 19. The electronic apparatus 10 uses, for recognizing the user voice 19, a voice cognition algorithm, program or application such as an acoustic model, a language model, a dictionary, etc. but the examples are not limited thereto.

Although FIG. 1 illustrates the electronic apparatus 10 as a display apparatus such as TV, the electronic apparatus 10 is not limited thereto and may be embodied as a smartphone, a tablet, a personal computer, a wearable device such as a smart watch, a multimedia player, an electronic picture frame, a home appliance such as a refrigerator, an artificial intelligence speaker to communicate with a user using an artificial intelligence algorithm, etc.

The electronic apparatus 10 sends a sound signal to an external speaker 20 and the external speaker 20 outputs a sound based on the sound signal sent from the electronic apparatus 10. For example, when the electronic apparatus 10 displays an image of a news channel and sends a sound signal corresponding to the image of the news channel to the external speaker 20, the external speaker 20 outputs a sound 17 of the news channel. Although FIG. 1 illustrates the external speaker 20 as a separate speaker, the external speaker 20 is not limited thereto and may be various external audio devices including a speaker. Below, for the sake of description, the disclosure will be described supposing the electronic apparatus 10 is a TV, while the external speaker 20 is a separate speaker.

When the electronic apparatus 10 receives the user voice 19 during receiving the sound 17 of the external speaker 20, the electronic apparatus 10 may obtain the user voice 19 by performing an echo elimination on the sound 17 of the external speaker 20. For example, as illustrated in FIG. 1, it is supposed that a user speaks the voice 19 to instruct a change into a baseball channel while the electronic apparatus 10 outputs the sound 17 of a news channel through the external speaker 20 which is at a first position. The electronic apparatus 10 may receive the user voice 19 though a microphone 12 during receiving the sound 17 of the news channel. The electronic apparatus 10 may obtain the user voice 19 to instruct the change into the baseball channel by performing the echo elimination on the sound 17 of the news channel among the sound 17 of the news channel and the user voice 19 which are received through the microphone 12.

Specifically, the electronic apparatus 10 of the embodiment may identify whether a correction of the echo elimination is needed, and, in response to identifying that the correction of the echo elimination is needed, perform the correction of the echo elimination on the sound received through the microphone 12. For example, if the external speaker 20 moves from the first position to a second position (see 21 of FIG. 1), the electronic apparatus 10 identifies that the correction of the echo elimination is needed. When the electronic apparatus 10 identifies that the correction of the echo elimination is needed, with regard to the sound 18 of the news channel output through the microphone 12 and the voice 19 to instruct the change into the baseball channel, the electronic apparatus 10 eliminates the sound 18 of the news channel and obtains the user voice 19 by performing the correction of the echo elimination.

In this way, the electronic apparatus 10 identifies whether the correction of the echo elimination is needed, and performs the correction of the echo elimination on the sound received through the microphone 12, and thereby it is possible to enhance the recognition rate for the user voice 19.

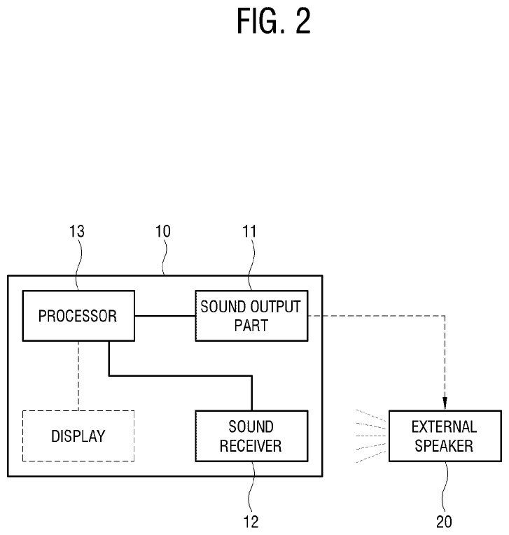

FIG. 2 illustrates a configuration of the electronic apparatus of FIG. 1. Referring to FIG. 2, the electronic apparatus 10 includes a sound output part 11, a sound receiver 12, and a processor 13.

The sound output part 11 is connected to the external speaker 20 and outputs a sound signal to the external speaker 20. The sound output part 11 may output the sound signal in a wired or wireless method according to a connection type. For example, the sound output part 11 may output the sound signal to the external speaker 30 through at least one of a wired communication such as high definition multimedia interface (HDMI), universal serial bus (USB), wired local area network, etc. or a wireless communication such as wireless HD (WiHD), wireless gigabit alliance (WiGig), Bluetooth, infrared data association (IrDA), Wi-Fi, ZigBee, Wi-Fi Direct (WFD), ultra-wideband (UWB), near field communication (NFC), etc.

The sound output part 11 may be provided in or outside the electronic apparatus 10, and be embodied as two or more communication modules or a single integrated module for performing the wired or wireless communication.

The sound receiver 12 receives at least one of the sound output through the external speaker 20 or the user voice 19. The sound receiver 12 may eliminate various noises that are included in the sound using a preprocess such as a frequency analysis on the received sound. The sound receiver 12 may be embodied as at least one microphone.

The processor 13 may control a general operation of the electronic apparatus 10. For example, the processor 13 may identify whether a correction of the echo elimination is needed for the sound signal received through the sound receiver 12. If the processor 13 identifies that the correction of the echo elimination is needed, the processor 13 eliminates the sound 18 output from the external speaker 20 and obtains only the user voice 19 to recognize the user voice 19 by performing the correction of the echo elimination on the sound received through the sound receiver 12.

The processor 13 may include a control program (or an instruction) for performing the general control to elements, a nonvolatile memory in which the control program is installed, a volatile memory in which at least a part of the installed control program is loaded, and at least one processor or central processing unit (CPU) for executing the loaded control program. Further, such a control program may be stored in another electronic apparatus other than the electronic apparatus 10.

The control program may include a program(s) actualized in the form of at least one among a basis input/output system (BIOS), a device driver, an operating system, a firmware, a platform, and an application program. According to an embodiment, the application program may be previously installed or stored when the electronic apparatus 10 is manufactured, or may be installed based on application data received from the outside when it is used in the future. The application data may for example be downloaded from an application market and the like server. Such a server is an example of a computer program product, but not limited to this example.

Further, the processor 13 may employ at least one of machine learning, a neural network or a deep-learning algorithm as a rule-based or artificial-intelligence algorithm to perform at least a part of data analysis, process, and result information generation for identifying whether the correction of the echo elimination is needed or performing the correction of the echo elimination.

However, FIG. 2 does not limit the elements of the electronic apparatus 10, and thus the electronic apparatus 10 may exclude some elements or include another element not shown in FIG. 2. For example, the electronic apparatus 10 may further include at least one of a display, a user input portion, a sensor, a power portion, a battery portion or a storage.

The display displays an image based on an image signal that is stored therein or received from outside. In case of the display displaying the image received from outside, the electronic apparatus 10 may further include an image signal receiver and an image signal processor.

Also, the display displays an image to perform the echo elimination. For example, the electronic apparatus 10 performs the echo elimination according to a user input where the display may ask the user whether the echo elimination is to be performed, or display a user interface (UI) to receive the user input from the user corresponding to the asking.

Examples of the display are not limited and may be embodied as liquid crystal, plasma, a light-emitting diode, an organic light-emitting diode, a surface-conduction electron-emitter, a carbon nano-tube, nano-crystal, etc.

The user input portion receives the user input and forwards the user input to the processor 13. The user input portion may be embodied as various forms according to a type of the user input, for example, a menu button which is provided outside of the electronic apparatus 10, a remote control signal receiver which receives a remote control signal corresponding to the user input from an external remote controller, or a touch screen which is provided on the display and receives a user touch input.

The sensor senses a position change such as movement, rotation, fallen-down, upside-down, etc. of the external speaker 20. For example, the sensor may be embodied as an image sensor which captures an image in front of the electronic apparatus 10 to obtain information on the position change of the external speaker 20 from the captured image, for example, a camera in a type of a complementary metal oxide semiconductor (CMOS) or a charge coupled device (CCD). Alternatively, the sensor may be embodied as an infrared sensor which measures time from when an infrared signal is output towards the electronic apparatus 10 to when the infrared signal reflects and returns to obtain information on the position change of the external speaker 20.

The power portion or the battery portion is supplied with power from outside according to the control of the processor 13 and supplies each configuration of the electronic apparatus 10 or stores the supplied power.

Meanwhile, the storage stores instructions, programs, applications or sound signals regarding various contents, etc. for controlling the electronic apparatus 10. For example, the storage may include a recording medium of at least one type among a flash memory type, a hard disk type, a multimedia card micro type, a card type memory (such as a secure digital (SD) memory, an extreme digital (XD) memory, etc.), a random access memory (RAM), a static random access memory (SRAM), etc.

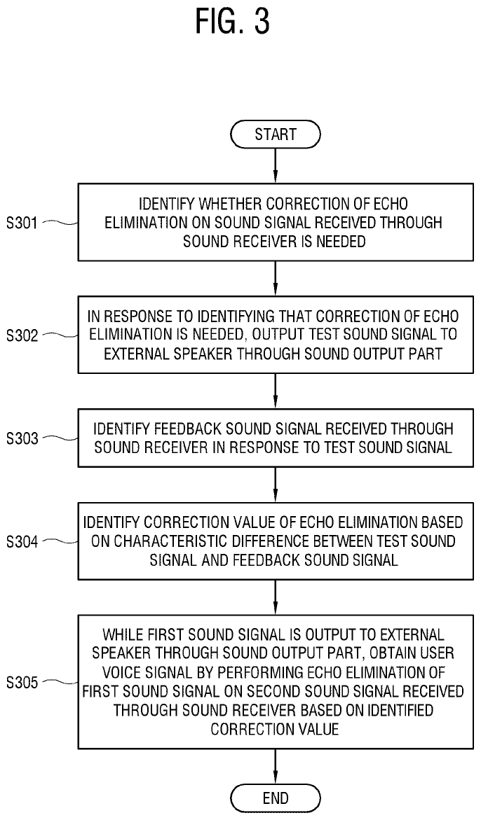

FIG. 3 illustrates a control method of the electronic apparatus of FIG. 1. The control method of the electronic apparatus of the embodiment may be performed by the processor 13 to execute the control program described above. Below, operations which are performed by the processor 13 to execute the control program will be described as, simply, operations of the processor 13.

Referring to FIG. 3, the processor 13 identifies whether the correction of the echo elimination on the sound signal which is received through the sound receiver 12 is needed (S301). For example, the processor 13 monitors the position change of the external speaker 20 and identifies whether the correction of the echo elimination on the sound signal which is received through the sound receiver 12 is needed according to the monitored position change.

In response to identifying that the correction of the echo elimination is needed, the processor 13 outputs a test sound signal to the external speaker 20 (S302). For example, if a position change 21 is sensed that the external speaker 20 moves from the first position to the second position over a distance by the monitoring of the external speaker 20, the processor 13 identifies that the correction of the echo elimination is needed, and outputs to the external speaker 20 the test sound signal to identify a correction value of the echo elimination corresponding to the position change 21.

The processor 13 identifies a feedback sound signal which is output from the external speaker 20 in response to the test sound signal and received through the sound receiver 12 (S303). For example, the processor 13 receives a feedback sound output from the external speaker 20 in response to the test sound signal, and identifies the feedback sound signal due to the feedback sound corresponding to the test sound signal in consideration of a characteristic such as magnitude, phase, frequency, etc. of the test sound signal.

The processor 13 identifies the correction value of the echo elimination based on a characteristic difference between the test sound signal and the feedback sound signal (S304). For example, at least one of rate, magnitude or phase of the correction value may be identified in consideration of a difference of at least one of the magnitude or phase between the test sound signal and the feedback sound signal.

While a first sound signal is output to the external speaker 20 through the sound output part 11, the processor 13 obtains a user voice signal by performing the echo elimination of the first sound signal on a second sound signal which is received through the sound receiver 12 based on the correction value (S305). For example, while a sound signal of a news channel is output to the external speaker 20 through the sound output part 11, the processor 13 eliminates the sound signal of the news channel and obtains the user voice signal by performing, based on the correction value, the echo elimination of the sound signal of the news channel on the sound signal due to the sound 18 of the news channel and on the user voice signal due to the user voice 19, which are received through the sound receiver 12.

In this way, according to the control method of the electronic apparatus 10 of the embodiment, the electronic apparatus 10 identifies whether the correction of the echo elimination is needed, and obtains the user voice signal by performing the correction of the echo elimination on the sound signal received through the sound receiver 12, and thereby it is possible to enhance the recognition rate for the user voice 19.

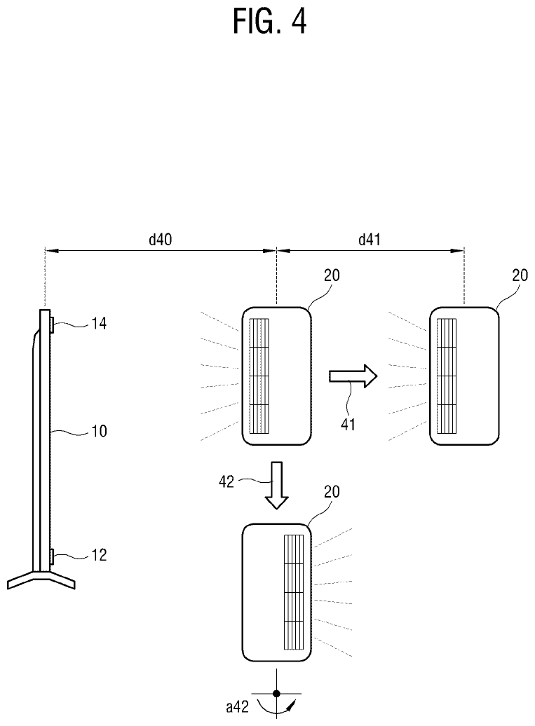

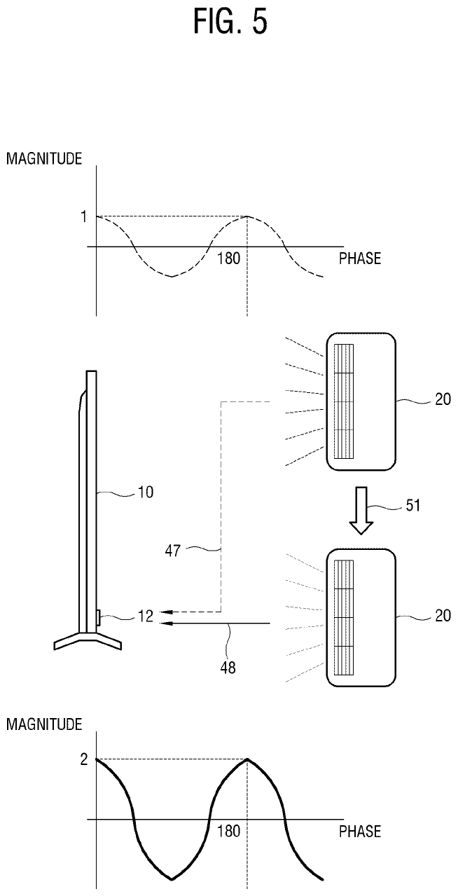

FIGS. 4 and 5 illustrate an example related to the operation S301 of FIG. 3 where an installation environment of the external speaker is changed. First, as illustrated in FIG. 4, it is supposed that the external speaker 20 moves from the first position, which is away from the electronic apparatus 10 by a first distance d40, to the second position which is away from the first position by a movement distance d41 (see 41 of FIG. 4).

The electronic apparatus 10 identifies whether to perform the correction of the echo elimination by identifying that the installation environment of the external speaker 20 is changed, according to the position change 41 or the movement distance d41 of the external speaker 20. For example, if the movement distance d41 is more than a predetermined distance, the electronic apparatus 10 identifies that the correction of the echo elimination is needed.

The identification of whether the installation environment of the external speaker 20 is changed may be based on information which is obtained through the sensor 14. For example, in case of the sensor 14 being embodied as a camera, the electronic apparatus 10 identifies the external speaker 20, senses the position change 41 of the external speaker 20 or measures the movement distance d41 of the external speaker 20 based on image information which is obtained through the camera 14. Further, the electronic apparatus 10 uses various sensors as well as the camera 13 and various image recognition algorithms for identifying the image, sensing the position change, or measuring the movement distance.

Meanwhile, the electronic apparatus 10 identifies that the installation environment of the external speaker 20 is changed, according to rotation 42 or rotation angle a42 of the external speaker 20 which is sensed through the sensor 14. For example, if the rotation angle a42 is more than a predetermined angle, the electronic apparatus 10 identifies that the correction of the echo elimination is needed. However, the change of the installation environment of the external speaker 20 is not limited to the position change or the rotation, and may include a position change such as fallen-down, upside-down, etc. of the external speaker 20 or a situation where a part or all of the external speaker 20 is hidden by a user or an obstacle.

With reference to FIG. 5, another example related to the operation S301 of FIG. 3 where the installation environment of the external speaker is changed will be described. Referring to FIG. 5, it is supposed that the external speaker 20 outputs a sound 47 which has a magnitude based on the sound signal output from the electronic apparatus 10 while the electronic apparatus 10 receives the sound 47 output from the external speaker 20 through the sound receiver 12.

The electronic apparatus 10 obtains information on the magnitude, that is, volume of the sound signal due to the sound 47 which is received through the sound receiver 12, and identifies that there is a change 51 in volume setting of the external speaker 20 based on the obtained information.

For example, the electronic apparatus 10 identifies that the sound signal which is caused by the sound 47 and received through the sound receiver 12 has 1 decibel (dB). In a case, the magnitude of the sound signal may be an average magnitude during a predetermined time, but is not limited thereto. If the sound signal by the sound 48 received through the sound receiver 12 is identified to have 2 dB, the electronic apparatus 10 identifies that there has been a change 51 in the volume setting where the volume of the external speaker 20 increases. However, the change 51 in the volume setting, that is, the change in magnitude of the sound signal is not limited thereto and may include a change in phase.

In this way, when there is the position change, the change in the volume setting, etc. of the external speaker 20, the electronic apparatus 10 identifies that there is a change in the installation environment of the external speaker 20.

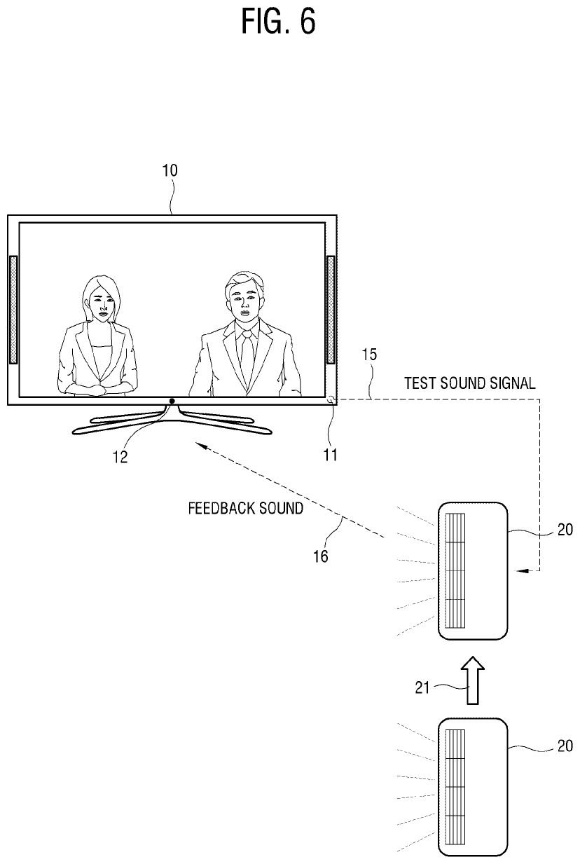

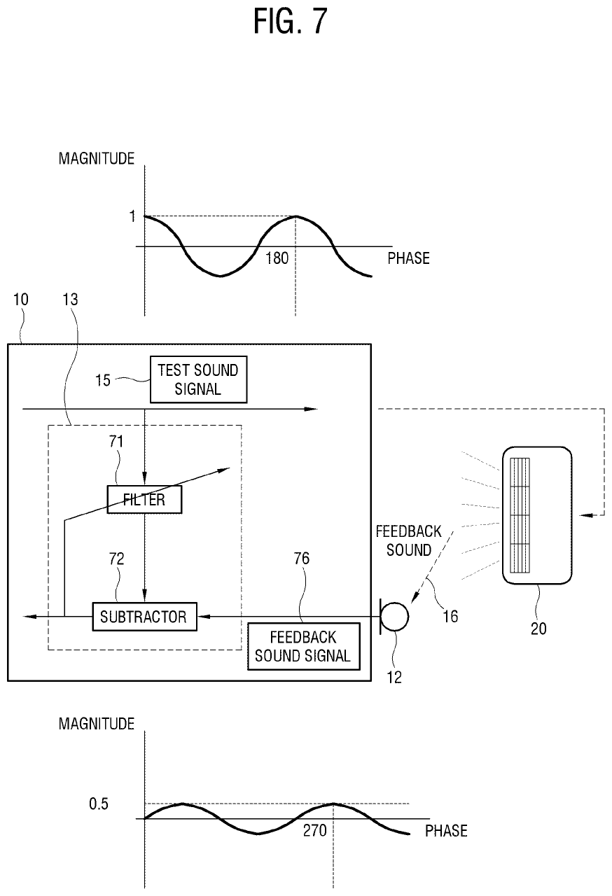

FIGS. 6 and 7 illustrate an example related to the operations S302 through S304 of FIG. 3 to identify the correction value of the echo elimination. First, referring to FIG. 6, when the electronic apparatus 10 identifies in the operation S301 that the correction of the echo elimination on the sound signal which is received through the sound receiver 12 is needed, the electronic apparatus 10 outputs the test sound signal 15 to the external speaker 20 through the sound output part 11. For example, if the position change 21 of the external speaker 20 is sensed, the electronic apparatus 10 outputs the test sound signal 15. In case of the electronic apparatus 10 being an artificial intelligence speaker, the electronic apparatus 10 may output the test sound signal 15 to the external speaker 20.

The electronic apparatus 10 receives the feedback sound 16, which is output from the external speaker 20 in response to the test sound signal 15, through the sound receiver 12, and identifies the correction value of the echo elimination based on the characteristic difference between the test sound signal 15 and the feedback sound signal due to the feedback sound 16.

Below, with reference to FIG. 7, an example of identifying the correction value of the echo elimination will be described in more detail. Referring to FIG. 7, the electronic apparatus 10 identifies the correction value which has a decrease ratio and delay between the test sound signal 15 and the feedback sound signal. Here, the decrease ratio represents a magnitude ratio between the test sound signal 15 and the feedback sound signal, whereas the delay represents a time difference between an output time of the test sound signal 15 and an input time of the feedback sound signal.

For example, when the magnitude of the feedback sound signal corresponding to the test sound signal 15, of which the magnitude is 1, is 0.5, the decrease ratio is identified to be 0.5, whereas when the phase of the feedback sound signal corresponding to the test sound signal 15, of which the phase is 180, is 270, the delay is identified to be 90. However, FIG. 7 does not limit the correction value to the decrease ratio or the time delay, and various correction values may be possible according to the change in the installation environment of the external speaker 20. Meanwhile, the processor 13 stores the identified correction value in the storage.

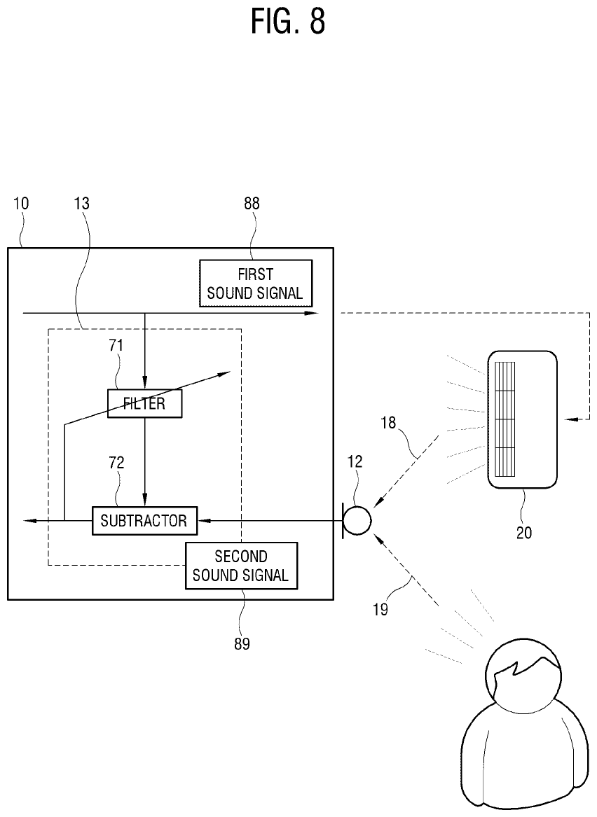

FIG. 8 illustrates an example related to the operation S305 of FIG. 3 to perform the echo elimination based on the identified correction value. Referring to FIG. 8, the electronic apparatus 10 includes a filter 71 and a subtractor 72 for performing the echo elimination based on the correction value. The filter 71 filters a first sound signal 88 which is output to the external speaker 20 using the correction value, and provides the filtered sound signal to the subtractor 72. For example, if the correction value is identified as the decrease rate of 0.5 and the time delay of 90, the filter 71 multiplies the sound signal 88 of a news channel, which is output to the external speaker 20, by the decrease rate of 0.5 and adds with the time delay of 90, and provides the filtered sound signal to the subtractor 72.

The subtractor 72 performs the echo elimination of the first sound signal 88 by subtracting the filtered sound signal from a second sound signal 89 which is caused by the second sound 18 and received through the sound receiver 12. For example, it is supposed that the sound signal 88 of the news channel is output to the external speaker 20, whereas the sound 18 of the news channel, which is output from the external speaker 20 in response to the sound signal 88 of the news channel, is received through the sound receiver 12. The subtractor 72 eliminates the sound signal 89 due to the sound 18 of the news channel by subtracting the filtered sound signal from the sound signal 89 due to the second sound 18 received through the sound receiver 12.

If the user voice 19 to instruct to change into a baseball channel is received while the sound signal 88 of the news channel is output, the subtractor 72 eliminates the sound signal 89 due to the sound 18 of the news channel by subtracting the filtered sound signal from the sound 18 of the news channel and the user voice 19 received through the sound receiver 12, and obtains the user voice signal due to the user voice 19.

However, FIG. 8 does not limit the configuration of performing the echo elimination to the filter 71 and the subtractor 72, and the processor 13 may perform the echo elimination with a configuration other than the filter 71 and the subtractor 72.

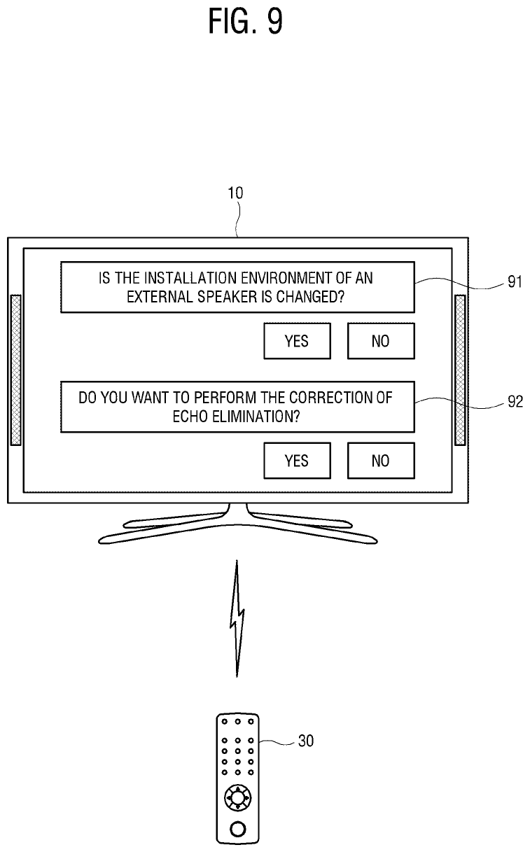

FIG. 9 illustrates an example related to the operation S301 of FIG. 3 to perform the correction of the echo elimination according to a user input. Referring to FIG. 9, the electronic apparatus 10 receives a user input through a remote controller 30. However, the configuration is not limited thereto and may be to receive the user input through various user input portions such as a menu button, a touch screen, etc.

If the change in the installation environment of the external speaker 20 such as the position change, the change in the volume setting, etc. is sensed, the electronic apparatus 10 displays a UI 91 on the display to ask whether the installation environment of the external speaker is changed. In response to that, if the user input that the installation environment is changed is received, the electronic apparatus 10 identifies that the correction of the echo elimination is needed and performs the correction of the echo elimination according to the operations S302 through S304 of FIG. 3.

Meanwhile, the electronic apparatus 10 may receive the user input for performing the correction of the echo elimination. For example, if there is the user input on a menu item or a button of the remote controller 30 representing the correction of the echo elimination even though the installation environment of the external speaker 20 is not changed, the electronic apparatus 10 performs the correction of the echo elimination according to the operations S302 through S304 of FIG. 3. In this case, the processor 13 displays a UI 82 to ask whether to perform the correction of the echo elimination and performs the correction of the echo elimination according to the user input.

In this way, the UI 91 to ask whether the installation environment of the external speaker is changed or the UI 82 to ask whether to perform the correction of the echo elimination is displayed, where it is possible to enhance user convenience on performing the correction of the echo elimination, because the correction of the echo elimination is prevented from being adversely performed against user's intention though the installation environment of the external speaker 20 is changed or the correction of the echo elimination can be performed according to the user's intention though the installation environment of the external speaker 20 is not changed.

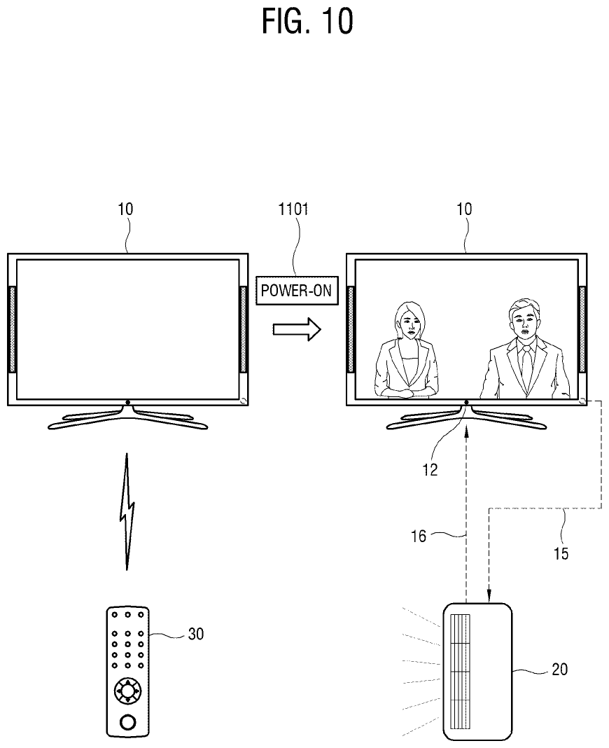

FIG. 10 illustrates an example related to the operation S301 of FIG. 3 to perform the correction of the echo elimination in response to power-on of the electronic apparatus 10. Referring to FIG. 10, the electronic apparatus 10 is powered on from power-off (see 1101 of FIG. 10). For example, the electronic apparatus 10 is powered on based on a user input on a power-on button of the remote controller 30.

In response to the power-on 1101, the electronic apparatus 10 identifies that the correction of the echo elimination on the external speaker 20 is needed, and performs the correction of the echo elimination according to the operations S302 through S304 of FIG. 3. However, the correction of the echo elimination is not performed only by the power-on 1101 and the electronic apparatus 10 may perform the correction of the echo elimination in response to performing a function such as initialization, reset, etc.

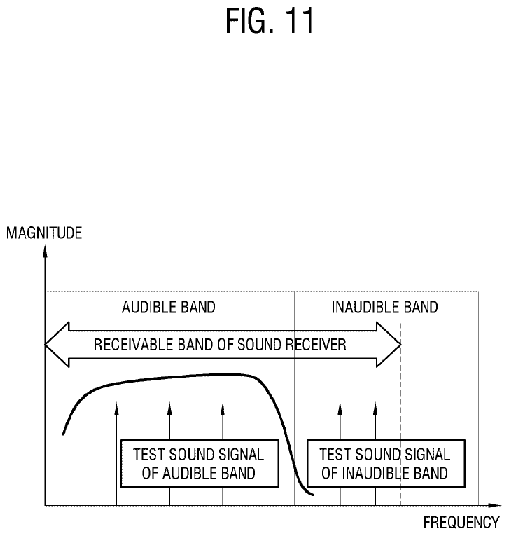

FIG. 11 illustrates an example related to the operation S302 of FIG. 3 where the test sound signal of an audible or inaudible band is output. Referring to FIG. 11, the electronic apparatus 10 outputs the test sound signal 15 to the external speaker 20 in response to the change in the installation environment of the external speaker 20. In this case, the electronic apparatus 10 outputs the test sound signal 15 of an audible or inaudible band.

For example, when the electronic apparatus 10 identifies that the correction of the echo elimination is needed, the electronic apparatus 10 identifies through the sensor 14 whether a user is present near or within a distance from the electronic apparatus 10. If the user is sensed to be present near or within the distance, the electronic apparatus 10 outputs the test sound signal 15 which has a frequency of the inaudible band to the external speaker 20.

In another example, if a content image is identified to be displayed or a sound to be output, the electronic apparatus 10 outputs the test sound signal 15 which has the frequency of the inaudible band to the external speaker 20. The frequency of the inaudible band is not audible to a user, but is a frequency of a band receivable by the sound receiver 12.

On the other hand, if no user is sensed to be present near or within the distance or if no content image or sound is identified to be displayed or output, the electronic apparatus 10 outputs the test sound signal 15 which has a frequency of the audible band to the external speaker 20. The test sound signal 15 which has the frequency of the audible or inaudible band is output individually, but the test sound signals 15 of the audible band and the inaudible band may be output at the same time or sequentially.

Although the exemplary embodiments have been described, the disclosure is not limited thereto and may be variously embodied within the scope of the claims.

1. An electronic apparatus comprising:
a sound receiver;
a sound output part configured to connect to an external speaker; and
a processor configured to:
identify whether a correction of echo elimination on a sound signal which is received through the sound receiver is needed,
in response to identifying that the correction is needed, control the sound output part to output a test sound signal,
receive through the sound receiver a feedback sound signal corresponding to the output test sound signal,
identify a correction value of the echo elimination based on a characteristic difference between the test sound signal and the feedback sound signal, and
obtain a user voice signal by performing the echo elimination of the first sound signal on the second sound signal received through the sound receiver based on the identified correction value, while the first sound signal is output to the external speaker through the sound output part.

2. The electronic apparatus according to claim 1, wherein the processor is further configured to identify whether the correction is needed based on a change in an installation environment of the external speaker.

3. The electronic apparatus according to claim 2, wherein the installation environment of the external speaker comprises a distance between the electronic apparatus and the external speaker.

4. The electronic apparatus according to claim 3, wherein the processor is further configured to:
obtain information on a position change of the external speaker sensed by a sensor, and
identify a change in the distance between the electronic apparatus and the external speaker based on the obtained information.

5. The electronic apparatus according to claim 2, wherein the installation environment of the external speaker comprises a volume setting of the external speaker.

6. The electronic apparatus according to claim 5, wherein the processor is further configured to:
obtain information on a magnitude of the sound signal received through the sound receiver, and
identify a change in the volume setting of the external speaker based on the obtained information.

7. The electronic apparatus according to claim 2, wherein the processor is further configured to identify the change in the installation environment of the external speaker based on a user input.

8. The electronic apparatus according to claim 7, wherein the processor is further configured to display a user interface to receive the user input.

9. The electronic apparatus according to claim 1, wherein the processor is further configured to identify whether the correction is needed in response to a power-on of the electronic apparatus.

10. The electronic apparatus according to claim 1, wherein the processor is further configured to identify the correction value of the echo elimination based on a difference in at least one of a magnitude or a phase between the test sound signal and the feedback sound signal.

11. The electronic apparatus according to claim 1, wherein the test sound signal has a frequency of an audible band or an inaudible band.

12. A method of controlling an electronic apparatus connected to an external speaker, the method comprising:
identifying whether a correction of echo elimination on a sound signal which is received through a sound receiver is needed,
in response to identifying that the correction is needed, controlling a sound output part to output a test sound signal,
identifying a feedback sound signal received through the sound receiver in response to the output test sound signal,
identifying a correction value of the echo elimination based on a characteristic difference between the test sound signal and the feedback sound signal, and
obtaining a user voice signal by performing the echo elimination of the first sound signal on the second sound signal received through the sound receiver based on the identified correction value, while the first sound signal is output to the external speaker through the sound output part.

13. The method according to claim 12, wherein the identifying whether the correction is needed comprises identifying whether the correction is needed based on a change in an installation environment of the external speaker.

14. The method according to claim 13, wherein the installation environment of the external speaker comprises a distance between the electronic apparatus and the external speaker.

15. A recording medium in which a computer program is stored, the computer program comprising a computer-readable code to perform a method of controlling an electronic apparatus, connected to an external speaker, the method comprising:
identifying whether a correction of echo elimination on a sound signal which is received through a sound receiver is needed,
in response to identifying that the correction is needed, controlling a sound output part to output a test sound signal,
identifying a feedback sound signal received through the sound receiver in response to the output test sound signal,
identifying a correction value of the echo elimination based on a characteristic difference between the test sound signal and the feedback sound signal, and
obtaining a user voice signal by performing the echo elimination of the first sound signal on the second sound signal received through the sound receiver based on the identified correction value, while the first sound signal is output to the external speaker through the sound output part.
